(19) United States
(12) Patent Application Publication
(10) Pub. No.: US 2026/0096514 A1
(43) Pub. Date: Apr. 9, 2026

(54) BALE EJECTION CONTROL SYSTEM FOR AN AGRICULTURAL HARVESTER

(71) Applicant: CNH Industrial America LLC, New Holland, PA (US)

(72) Inventors: Nicholas Shane, Andalusia, IL (US); Jordan Beckhusen, McGregor, TX (US); Jason D. Wattonville, Alleman, IA (US); Douglas J. Bollin, Port Byron, IL (US); Aryon Wayne Shondel, Davenport, IA (US)

(21) Appl. No.: 19/352,729

(22) Filed: Oct. 8, 2025

Related U.S. Application Data
(60) Provisional application No. 63/704,872, filed on Oct. 8, 2024.

(51) Int. Cl. A01F 15/07

(52) U.S. Cl. CPC A01F 15/071; A01F 2015/074; A01F 2015/076

(57) ABSTRACT

A bale ejection control system for an agricultural harvester includes a controller having a processor and a memory. The controller is configured to receive a bale wrap presence signal indicative of presence of a bale wrap on a bale of agricultural product within a baler of the agricultural harvester and to receive a bale absence signal indicative of absence of a previous bale on a bale handler of the agricultural harvester. The controller is also configured to determine a bale wrapping process is complete based on presence of the bale wrap on the bale and to determine the bale handler is available based on absence of the previous bale on the bale handler. Furthermore, the controller is configured to control a bale ejection system to eject the bale from the baler in response to determining the bale wrapping process is complete and the bale handler is available.

### CROSS-REFERENCE TO RELATED APPLICATION

This application claims priority from and the benefit of U.S. Provisional Application Ser. No. 63/704,872, entitled “BALE EJECTION CONTROL SYSTEM FOR AN AGRICULTURAL HARVESTER”, filed Oct. 8, 2024, which is hereby incorporated by reference in its entirety.

### BACKGROUND

The present disclosure relates generally to a bale ejection control system for an agricultural harvester.

Agricultural harvesters are used to harvest agricultural products (e.g., cotton or other natural material(s)). For example, an agricultural harvester may include a header having row units configured to harvest the agricultural product from a field. The agricultural harvester may also include an air-assisted conveying system configured to move the agricultural product from the row units to an accumulator. The agricultural product may then be fed into a baler via a conveying system. The baler may compress the agricultural product into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale.

### BRIEF DESCRIPTION

In certain embodiments, a bale ejection control system for an agricultural harvester includes a controller having a processor and a memory. The controller is configured to receive a bale wrap presence signal indicative of presence of a bale wrap on a bale of agricultural product within a baler of the agricultural harvester and to receive a bale absence signal indicative of absence of a previous bale on a bale handler of the agricultural harvester. The controller is also configured to determine a bale wrapping process is complete based on presence of the bale wrap on the bale and to determine the bale handler is available based on absence of the previous bale on the bale handler. Furthermore, the controller is configured to control a bale ejection system to eject the bale from the baler in response to determining the bale wrapping process is complete and the bale handler is available.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings.

FIG. 1 is a perspective view of an embodiment of an agricultural harvester having an agricultural product transport assembly and a baler.

FIG. 2 is a schematic view of an embodiment of an agricultural product transport assembly, an embodiment of a baler, and an embodiment of a bale handler system that may be employed within the agricultural harvester of FIG. 1.

FIG. 3 is a block diagram of an embodiment of a bale ejection control system that may be employed within the baler and the bale handler system of FIG. 2.

FIG. 4 is a flow diagram of an embodiment of a method for ejecting a bale of agricultural product from a baler.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

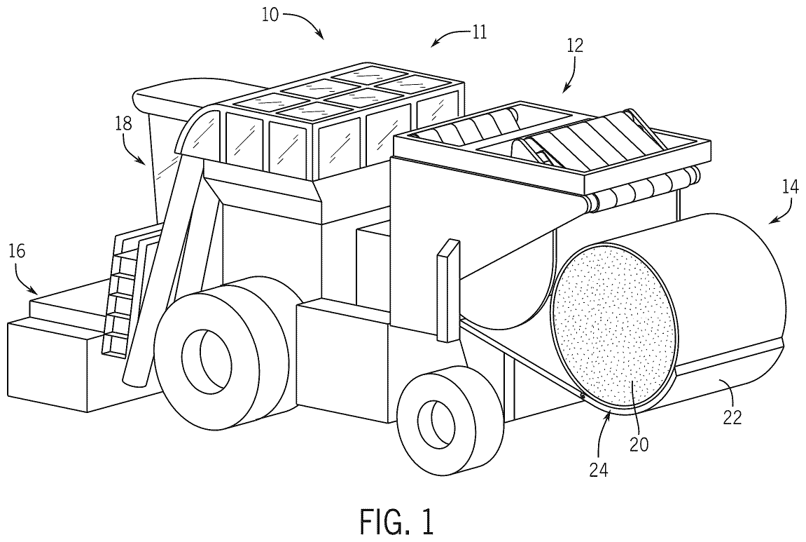

FIG. 1 is a perspective view of an embodiment of an agricultural harvester 10 (e.g., harvester, agricultural harvester, etc.) having an agricultural product transport assembly 11 and a baler 12. The agricultural harvester 10 harvests agricultural product (e.g., cotton) from a field and forms the agricultural product into bales 14 (e.g., agricultural bales). In the illustrated embodiment, the agricultural harvester 10 includes a header 16 having row units that harvest the agricultural product from the field. Additionally, the agricultural product transport assembly 11 of the agricultural harvester 10 includes an air-assisted conveying system 18 that moves the agricultural product from the row units of the header 16 to an accumulator assembly of the agricultural product transport assembly 11. The agricultural product transport assembly 11 also includes a conveying system that conveys the agricultural product from the accumulator assembly into the baler 12 (e.g., agricultural baler). The baler 12 is supported by and/or mounted within or on a chassis of the agricultural harvester 10. The baler 12 may form the agricultural product 20 into round bales 14. However, in other embodiments, the baler of the agricultural harvester may form the agricultural product into square bales, polygonal bales, or bales of other suitable shape(s). After forming the agricultural product 20 into a bale 14, a bale wrapping system of the agricultural harvester 10 wraps the bale with a bale wrap to secure the agricultural product 20 within the bale 14 and to generally maintain a shape of the bale 14.

After the bale 14 is wrapped, a bale ejection system of the baler 12 ejects the bale to a bale handler 22 of a bale handler system 24. The bale handler 22 supports the bale 14 (e.g., while a subsequent bale is being formed by the baler). In addition, the bale handler system 24 discharges the bale 14 onto the surface of the field. For example, one or more actuators of the bale handler system 24 may drive the bale handler 22 downwardly to enable the bale 14 to roll onto the surface of the field. After the bale 14 is discharged, the actuator(s) of the bale handler system 24 may drive the bale handler 22 to a position that receives the subsequent bale or to a storage (e.g., home) position.

In certain embodiments, the agricultural harvester 10 includes a bale ejection control system that controls the bale ejection system to automatically eject the bale 14 from the baler 12. As discussed in detail below, the bale ejection system includes a controller having a processor and a memory. The controller is configured to receive a bale wrap presence signal (e.g., from a bale wrap presence sensor) indicative of presence of the bale wrap on the bale 14 of the agricultural product 20 within the baler 12 of the agricultural harvester 10. Furthermore, the controller is configured to receive a bale absence signal (e.g., from a bale absence sensor) indicative of absence of a previous bale 14 on the bale handler 22 of the bale handler system 24 of the agricultural harvester 10. The controller is also configured to determine a bale wrapping process is complete based on presence of the bale wrap on the bale 14, and the controller is configured to determine the bale handler 22 is available to receive a bale 14 (e.g., a subsequent bale) based on absence of the previous bale on the bale handler 22. In addition, the controller is configured to control the bale ejection system to eject the bale (e.g., the subsequent bale) from the baler 12 in response to determining the bale wrapping process is complete and the bale handler 22 is available. Accordingly, the wrapped bale may be ejected from the baler 14 to the bale handler 22 without operator input, thereby enhancing the efficiency of the baling process (e.g., as compared to a system in which the operator manually controls the bale ejection system to eject the bale).

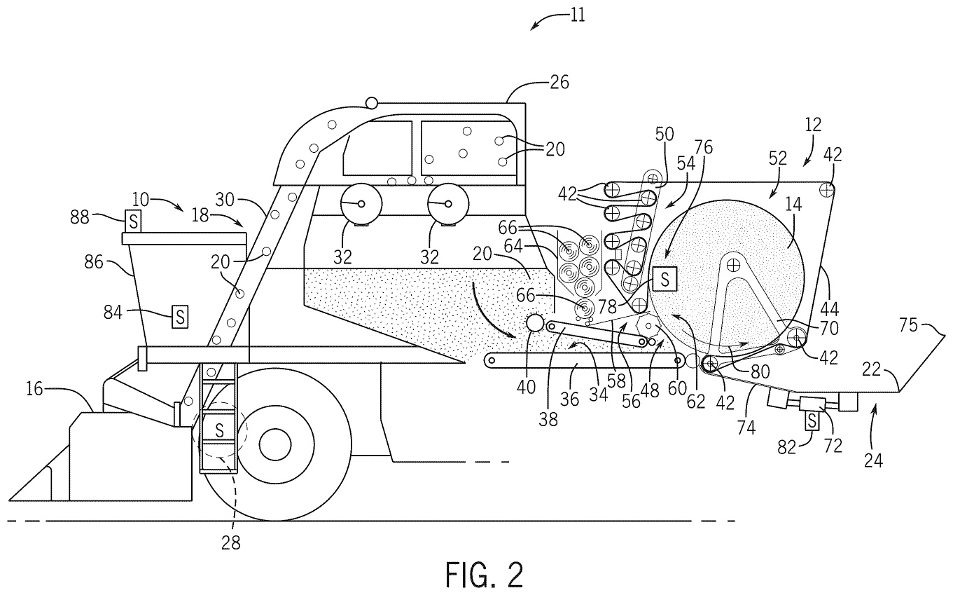

FIG. 2 is a schematic view of an embodiment of an agricultural product transport assembly 11, an embodiment of a baler 12, and an embodiment of a bale handler system 24 that may be employed within the agricultural harvester 10 of FIG. 1. As previously discussed, the header 16 of the agricultural harvester 10 includes row units that harvest the agricultural product 20 (e.g., cotton) from the field. Furthermore, the air-assisted conveying system 18 moves the agricultural product 20 from the row units of the header 16 to the accumulator assembly 26. In the illustrated embodiment, the air-assisted conveying system 18 includes a conveying air source 28 that outputs a conveying air flow through one or more ducts 30. Each duct 30 receives the agricultural product 20 (e.g., cotton) from the header 16, and the conveying air flow output by the conveying air source 28 drives the agricultural product to move through the duct(s) 30 from the header 16 to the accumulator assembly 26. In the illustrated embodiment, the agricultural product transport assembly 11 includes augers 32 that distribute the agricultural product 20 (e.g., cotton) laterally across the accumulator assembly 26 (e.g., crosswise to the downward movement of the agricultural product through the accumulator assembly). In the illustrated embodiment, the agricultural product transport assembly 11 includes two augers 32. However, in other embodiments, the agricultural product transport assembly may include more or fewer augers (e.g., 0, 1, 3, 4, or more).

In the illustrated embodiment, the conveying system 34 of the agricultural product transport assembly 11 includes a first belt (e.g., belt) 36 that moves the agricultural product 20 from the accumulator assembly 26 to the baler 12. The first belt 36 rotates in a first rotational direction to move an agricultural product engaging surface of the first belt 36 toward the baler 12. Furthermore, in the illustrated embodiment, the conveying system 34 includes a second belt 38 positioned on an opposite side of the agricultural product 20 from the first belt 36, and the second belt 38 cooperates with the first belt 36 to move the agricultural product 20 from the accumulator assembly 26 to the baler 12. Furthermore, in the illustrated embodiment, the conveying system 34 includes an agitation roller 40 positioned upstream of the second belt 38. The agitation roller 40 agitates the agricultural product 20 entering the pair of opposing belts, thereby enhancing the uniformity of the distribution of the agricultural product passing through the pair of opposing belts.

In the illustrated embodiment, the baler 12 includes multiple rollers 42 that support and/or drive rotation of one or more belts 44. For example, one or more rollers 42 engage the belt(s) 44, which enable the belt(s) 44 to move along the pathway defined by the rollers 42 and the bale 14. One or more rollers 42 are driven to rotate via a belt drive system (e.g., including electric motor(s), hydraulic motor(s), pneumatic motor(s), etc.). The belt(s) 44 circulate around the pathway defined by the rollers 42 and the bale 14. Movement of the belt(s) 44 captures agricultural product 20 from the conveying system 34 and draws the agricultural product 20 into a cavity 48, where the agricultural product 20 is gradually built up to form the bale 14.

In the illustrated embodiment, the baler 12 includes a tension arm 50 that establishes tension within the belt(s) 44. As the agricultural product 20 builds within the cavity 48, the agricultural product 20 applies a force to the belt(s) 44 that urges a first portion 52 of the belt(s) 44 surrounding the bale 14 to expand. Concurrently, the size of a second portion 54 (e.g., serpentine portion) of the belt(s) 44 is reduced. Accordingly, the second portion 54 of the belt(s) 44 provides the increasing belt length for the expanding first portion 52. In the illustrated embodiment, the second portion 54 of the belt(s) 44 is established by fixed rollers 42 (e.g., rollers fixed to a housing/frame of the baler 12) and rollers 42 coupled to the tension arm 50, which is pivotable relative to the fixed rollers 42 (e.g., relative to the housing/frame of the baler 12). Accordingly, as the agricultural product 20 builds within the cavity 48, the tension arm 50 is driven to rotate, thereby reducing the size of the second portion 54 and enabling the first portion 52 to expand.

Once the bale 14 reaches a desired size, a bale wrapping system 56 wraps the bale 14 with a bale wrap 58 to secure the agricultural product within the bale 14 and to generally maintain a shape of the bale 14, such as the round shape in the illustrated embodiment. In other embodiments, the shape of the bale may be rectangular, polygonal, or another suitable shape. The bale wrap 58 may be fed into contact with the bale 14 using one or more rollers and/or one or more belts of a bale wrap feeding assembly. The roller(s) and/or the belt(s) drive the bale wrap 58 toward a starter roller 60 (e.g., bale wrap feeder). The starter roller 60 rotates to feed the bale wrap 58 into the cavity 48 of the baler 12 at a feeding location 62, thereby driving the bale wrap 58 into contact with the bale 14. The bale wrap 58 is captured between the bale 14 and the belt(s) 44. Accordingly, rotation of the bale 14 draws the bale wrap 58 around the bale 14, thereby wrapping the bale 14. After the bale 14 is wrapped, the bale 14 is ejected from the baler 12, and the process of forming a subsequent bale may be initiated. While the starter roller 60 feeds the bale wrap 58 into the cavity 48 in the illustrated embodiment, in other embodiments, the agricultural harvester may include another suitable bale wrap feeder that feeds the bale wrap into the cavity. For example, in certain embodiments, the agricultural harvester may include a movable wrap guide (e.g., duck bill) that engages the bale wrap while the movable wrap guide is in a first position and to move to a second position to feed the bale wrap into the cavity at the feeding location.

In certain embodiments, during the harvesting process, the conveying system 34 and the baler 12 may be periodically activated to transfer the agricultural product 20 from the accumulator assembly 26 to the baler 12 and to form the bale 14. For example, as the agricultural harvester 10 traverses a field, the agricultural product 20 may accumulate within the accumulator assembly 26. After a selected duration, the conveying system 34 may be activated to transfer the agricultural product 20 from the accumulator assembly 26 to the baler 12. For example, the conveying system 34 may move the agricultural product 20 toward the baler 12 at a significantly faster rate than the air-assisted conveying system 18 moves the agricultural product 20 into the accumulator assembly 26. Concurrently with activation of the conveying system 34, the baler 12 may be activated to initiate the bale forming process, as described above. After another selected duration, the conveying system 34 and the baler 12 may be deactivated to enable the accumulator assembly 26 to collect additional agricultural product 20. In certain embodiments, the conveying system 34 and the baler 12 may be activated four or five times to enable the bale 14 to reach the desired size. As previously discussed, once the bale reaches the desired size, the bale wrapping system 56 wraps the bale 14 with the bale wrap 58. Because the conveying system 34 and the baler 12 are periodically activated, the agricultural harvester 10 may utilize less energy during the harvesting process (e.g., as compared to continuously operating the conveying system and the baler).

In the illustrated embodiment, the agricultural harvester 10 includes a bale wrap assembly storage compartment 64 that stores multiple bale wrap assemblies 66. In certain embodiments, each bale wrap assembly 66 includes a shaft and a bale wrap disposed about the shaft to form a roll of the bale wrap. However, in other embodiments, the shaft may be omitted, and the bale wrap may be arranged in a roll (e.g., with a hollow region at the center).

Furthermore, the agricultural harvester 10 includes a bale ejection system that ejects the bale 14 from the baler 12 into the bale handler 22 of the bale handler system 24. In certain embodiments, the bale ejection system includes one or more actuators that drive pendulum arms 70 of the baler 12 to rotate upwardly from the illustrated bale formation position to a bale ejection position. As the pendulum arms 70 rotate upwardly toward the bale ejection position, the rollers 42 coupled to the pendulum arms 70 move the belt(s) at a rear portion of the baler 12, thereby forming a gap sufficiently large for the wrapped bale to exit the cavity 48 of the baler 12. In addition, the tension within the belt(s) 44, which is established by the tension arm 50, causes the belt(s) to drive the wrapped bale out of the cavity 48 as the pendulum arms 70 rotate upwardly. Accordingly, the wrapped bale is ejected from the cavity 48 of the baler 12 as the pendulum arms 70 rotate upwardly from the illustrated bale formation position to the bale ejection position. While a bale ejection system having actuator(s) that drive the pendulum arms 70 to rotate is disclosed above, in certain embodiments, the bale ejection system may include any other suitable device(s) that eject the bale from the cavity, such as one or more actuators that drive a door positioned at a rear of the baler to open.

In addition, the bale handler 22 of the bale handler system 24 receives the bale 14 from the baler 12 as the bale 14 is ejected from the baler 12. In the illustrated embodiment, the bale handler system 24 includes a hydraulic cylinder 72 coupled to the bale handler 22 and to a ramp 74 that is coupled to the chassis of the agricultural harvester 10. The hydraulic cylinder 72 drives the bale handler 22 from the illustrated receiving position to a discharge position. While the bale handler is in the illustrated receiving position, the bale handler 22 may receive the bale 14 from the baler 12 (e.g., via the ramp 74) and support the bale 14 (e.g., for transport to a desired discharge location). Furthermore, the hydraulic cylinder 72 drives the bale handler 22 to rotate downwardly such that a distal end 75 of the bale handler 22 is positioned at or adjacent to the surface of the field. As the bale handler 22 rotates downwardly, the bale 14 supported by the bale handler 22 may roll downwardly along the bale handler 22 to the surface of the field. After the bale 14 is discharged, the hydraulic cylinder 72 may drive the bale handler 22 back to the illustrated receiving position to receive a subsequent bale 14. Furthermore, in certain embodiments, the hydraulic cylinder 72 may drive the bale handler 22 to rotate upwardly from the illustrated receiving position to a transport position (e.g., home position), thereby reducing the length of the agricultural harvester during harvesting operations. While the bale handler system 24 includes a single hydraulic cylinder 72 in the illustrated embodiment, in other embodiments, the bale handler system may include multiple hydraulic cylinders and/or one or more other suitable type(s) of actuators, such as pneumatic cylinder(s), electric linear actuator(s), other suitable type(s) of actuator(s), or a combination thereof.

As discussed in detail below, the agricultural harvester 10 includes a bale ejection control system 76 having a bale wrap presence sensor 78 directed toward the bale 14 within the cavity 48 of the baler 12. The bale wrap presence sensor 78 outputs a sensor signal indicative of presence of the bale wrap 58 on the bale 14. In the illustrated embodiment, the bale wrap presence sensor 78 is disposed within the baler 12 proximate to the feeding location 62, and the bale wrap presence sensor 78 is directed towards a portion of the bale 14 immediately upstream of the feeding location 62 with respect to a path 80 of the bale wrap 58 around the bale 14. Accordingly, the bale wrap presence sensor 78 may monitor presence of the bale wrap 58 on the bale 14 at a location that indicates the bale wrap 58 substantially circumscribes the bale 14. As used herein, “immediately upstream” of the feeding location with respect to the path of the bale wrap around the bale refers to a location that is at least 345 degrees around the bale from the feeding location along the path of the bale wrap around the bale (e.g., less than or equal to 15 degrees from the feeding location along the circumference of the bale). While the bale wrap presence sensor 78 is disposed within the baler 12 proximate to the feeding location 62 in the illustrated embodiment, in other embodiments, the bale wrap presence sensor may be disposed at another suitable location within the agricultural harvester. Furthermore, while the bale wrap presence sensor 78 is directed towards a portion of the bale 14 immediately upstream of the feeding location 62 with respect to the path 80 of the bale wrap 58 around the bale 14 in the illustrated embodiment, in other embodiments, the bale wrap presence sensor may be directed towards another suitable portion of the bale.

The bale ejection control system 76 also includes a bale absence sensor 82 that outputs a bale absence signal indicative of absence of a previous bale (e.g., a bale formed within the baler prior to the illustrated bale 14) on the bale handler 22 of the bale handler system 24. In the illustrated embodiment, the bale absence sensor 82 includes a fluid pressure sensor that monitors a fluid pressure within the hydraulic cylinder 72 of the bale handler system 24. For example, in certain embodiments, a weight monitoring system determines a weight of the previous bale on the bale handler 22 based on the fluid pressure within the hydraulic cylinder 72. The weight of the previous bale urges the bale handler 22 to rotate downwardly. However, the downward rotation is blocked by the hydraulic cylinder 72, which increases the fluid pressure within the hydraulic cylinder 72. Accordingly, the weight monitoring system may determine the weight of the previous bale based on feedback from the bale absence sensor 82, which monitors the fluid pressure within the hydraulic cylinder 72. In addition, a controller of the bale ejection control system 76 may determine that the previous bale is absent from the bale handler 22 based on feedback from the bale absence sensor 82 (e.g., in response to determining that the fluid pressure is less than a threshold fluid pressure). While the bale absence sensor 82 includes the fluid pressure sensor in the illustrated embodiment, in other embodiments, the bale absence sensor may include other suitable type(s) of sensing device(s) (e.g., alone or in combination with the fluid pressure sensor), such as a pressure switch positioned on the bale handler, a camera directed toward the bale handler, a LiDAR sensor directed towards the bale handler, a strain gauge coupled to the bale handler, a load pin coupled to the bale handler, other suitable type(s) of sensing device(s), or a combination thereof. As used herein, “absence of a previous bale on the bale handler” refers to no bale being present on the bale handler (e.g., not just absence of the bale most recently formed by the bale handler). For example, while a first bale is being formed in the baler (e.g., before any bale is ejected to the bale handler), the previous bale is absent from the bale handler.

As discussed in detail below, the bale ejection control system 76 includes a controller communicatively coupled to the bale wrap presence sensor 78 and to the bale absence sensor 82. The controller includes a processor and a memory, and the controller is configured to receive the bale wrap presence signal from the bale wrap presence sensor and to receive the bale absence signal from the bale absence sensor. Furthermore, the controller is configured to determine a bale wrapping process is complete (e.g., the bale 14 has been wrapped by the bale wrap 58 to form a wrapped bale) based on presence of the bale wrap 58 on the bale 14, and the controller is configured to determine the bale handler 22 of the bale handler system 24 is available to receive the bale 14 (e.g., subsequent bale) based on absence of the previous bale on the bale handler. In addition, the controller is configured to control the bale ejection system to eject the bale 14 from the baler 12 in response to determining the bale wrapping process is complete and the bale handler 22 is available. Accordingly, the wrapped bale may be ejected from the baler without operator input, thereby enhancing the efficiency of the baling process (e.g., as compared to a system in which the operator manually controls the bale ejection system to eject the bale).

In the illustrated embodiment, the bale ejection control system 76 also includes an operator presence sensor 84 communicatively coupled to the controller. The operator presence sensor 84 outputs an operator presence signal indicative of presence of the operator within a cab 86 of the agricultural harvester 10. The controller is configured to receive the operator presence signal and to determine the operator is present based on the presence of the operator within the cab 86. In certain embodiments, the controller is configured to control the bale ejection system to eject the bale 14 from the baler 12 in response to determining the bale wrapping process is complete, the bale handler 22 is available, and the operator is present. Because the operator is in the cab during the harvesting process, ejecting the bale only while the operator is in the cab may cause the bale to be ejected only during the harvesting process. While a controller configured to control the bale ejection system to eject the bale in response to determining the operator is present in the cab is disclosed above, in certain embodiments, the controller may control the bale ejection system to eject the bale without determining the operator is present in the cab (e.g., in response to determining the bale wrapping process is complete and the bale handler is available). In such embodiments, the operator presence sensor may be omitted.

Furthermore, in the illustrated embodiment, the bale ejection control system 76 includes a position sensor 88 communicatively coupled to the controller. The position sensor 88 outputs a position signal indicative of a position of the agricultural harvester 10 within a field and, in certain embodiments, a speed signal indicative of a speed of the agricultural harvester through the field. The controller is configured to receive the position signal and to determine the agricultural harvester is at a target position based on the position of the agricultural harvester. For example, the controller may store a map with a target location for ejecting each bale. The controller may determine that the agricultural harvester is at the target position in response to determining a difference between the target position and the position of the agricultural harvester within the field is less than a threshold distance. In certain embodiments, the controller is configured to control the bale ejection system to eject the bale from the baler in response to determining the bale wrapping process is complete, the bale handler is available, and the agricultural harvester is at the target position. In addition, in certain embodiments, the controller is configured to receive the speed signal indicative of the speed of the agricultural harvester through the field and to determine the agricultural harvester is within a target speed range based on the speed of the agricultural harvester. Furthermore, the controller is configured to control the bale ejection system to eject the bale from the baler in response to determining the bale wrapping process is complete, the bale handler is available, and the agricultural harvester is within the target speed range. The target speed range may be selected to correspond to the speed range of the agricultural harvester during the harvesting process. Accordingly, the bale ejection control system may only eject the bale during the harvesting process. In certain embodiments, the controller is configured to control the bale ejection system to eject the bale in response to determining the agricultural harvester is at the target position and the agricultural harvester is within the target speed range. However, in other embodiments, the controller may control the bale ejection system to eject the bale without determining the agricultural harvester is at the target position and/or without determining the agricultural harvester is within the target speed range. Accordingly, in certain embodiments, the position sensor may be omitted.

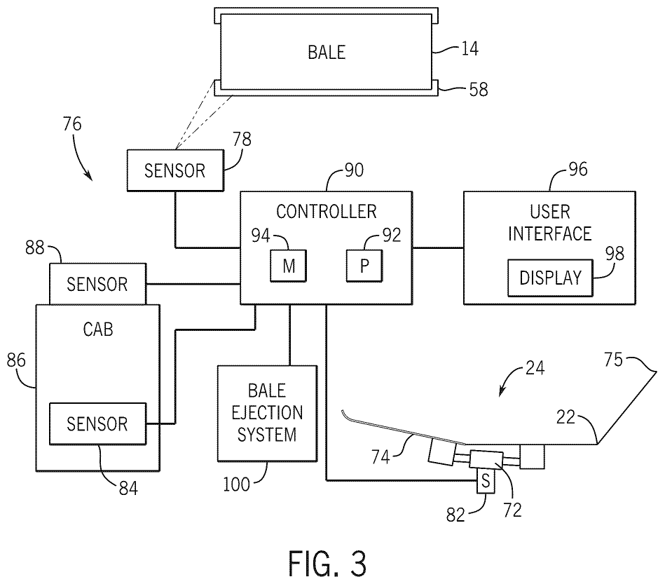

FIG. 3 is a block diagram of an embodiment of a bale ejection control system 76 that may be employed within the baler and the bale handler system 24 of FIG. 2. As previously discussed, the bale wrap presence sensor 78 of the bale ejection control system 76 is directed towards the bale 14 within the cavity of the baler of the agricultural harvester. In addition, the bale wrap presence sensor 78 outputs a sensor signal indicative of presence of the bale wrap 58 on the bale 14. The bale wrap presence sensor 78 may include any suitable type(s) of sensing device(s) that monitor the presence of the bale wrap 58 on the bale 14. For example, in certain embodiments, the bale wrap presence sensor 78 includes an ultrasonic sensor that emits an ultrasonic signal toward the bale and receives a return ultrasonic signal. Due to the difference in ultrasonic reflectivity between the agricultural product (e.g., cotton) of the bale and the bale wrap (e.g., plastic bale wrap), the ultrasonic sensor outputs the bale wrap presence signal indicative of presence of the bale wrap on the bale. For example, the ultrasonic sensor may output a bale wrap presence signal indicative of presence of the bale wrap on the bale in response to receiving a return ultrasonic signal having a magnitude greater than a threshold value (e.g., which indicates that the emitted ultrasonic signal reflected off the higher ultrasonic reflectivity bale wrap, as compared to the lower ultrasonic reflectivity agricultural product). In addition, in certain embodiments, the bale wrap presence sensor 78 includes a color contrast sensor that monitors a difference in color between the bale wrap and the agricultural product within the bale. Due to the difference in color, the color contrast sensor outputs the bale wrap presence signal indicative of presence of the bale wrap on the bale. Furthermore, in certain embodiments, the sensor may include a camera, an infrared sensor, a LiDAR sensor, a radar sensor, a millimeter wave sensor, a terahertz sensor, other suitable type(s) of sensing device(s), or a combination thereof (e.g., alone or in combination with the ultrasonic sensor and/or the color contrast sensor).

Furthermore, in certain embodiments, the bale wrap presence sensor 78 may include a tag reader that reads a tag coupled to the bale wrap 58, applied to the bale wrap 58, or formed within the bale wrap 58. For example, the tag may include a visible code (e.g., bar code, quick response (QR) code, etc.) coupled to the bale wrap (e.g., as a sticker), applied to the bale wrap (e.g., via a printing process), or formed within the bale wrap (e.g., via an embossing process), and the tag reader may include an optical scanner that reads the visible code. Furthermore, the tag may include a radio frequency identification (RFID) tag coupled to the bale wrap, and the tag reader may include an RFID reader. In certain embodiments, the tag may be positioned proximate to a leading end of the bale wrap, and the tag reader may be directed toward a portion of the bale 14 immediately upstream of the feeding location with respect to the path of the bale wrap 58 around the bale 14. Accordingly, the bale tag reader may monitor presence of the bale wrap 58 on the bale 14 at a location that indicates the bale wrap 58 substantially circumscribes the bale 14.

Furthermore, as previously discussed, the bale absence sensor 82 of the bale ejection control system 76 outputs a bale absence signal indicative of absence of a previous bale on the bale handler 22 of the bale handler system 24. In the illustrated embodiment, the bale absence sensor 82 includes a fluid pressure sensor that monitors a fluid pressure within the hydraulic cylinder 72 of the bale handler system 24. While the bale absence sensor 82 includes the fluid pressure sensor in the illustrated embodiment, in other embodiments, the bale absence sensor may include other suitable type(s) of sensing device(s) (e.g., alone or in combination with the fluid pressure sensor), such as a pressure switch positioned on the bale handler, a camera directed toward the bale handler, a strain gauge coupled to the bale handler, other suitable type(s) of sensing device(s), or a combination thereof.

In the illustrated embodiment, the bale ejection control system 76 includes a controller 90 communicatively coupled to the bale wrap presence sensor 78 and to the bale absence sensor 82. In certain embodiments, the controller 90 is an electronic controller having electrical circuitry configured to receive the bale wrap presence signal from the bale wrap presence sensor 78 and the bale absence signal from the bale absence sensor 82. In the illustrated embodiment, the controller 90 includes a processor 92, such as a microprocessor, and a memory device 94. The controller 90 may also include one or more storage devices and/or other suitable components. The processor 92 may be used to execute software, such as software for receiving the bale wrap presence signal from the bale wrap presence sensor 78 and the bale absence signal from the bale absence sensor 82, and so forth. Moreover, the processor 92 may include multiple microprocessors, one or more “general-purpose” microprocessors, one or more special-purpose microprocessors, and/or one or more application specific integrated circuits (ASICs), or some combination thereof. For example, the processor 92 may include one or more reduced instruction set (RISC) processors.

The memory device 94 may include a volatile memory, such as random access memory (RAM), and/or a nonvolatile memory, such as read-only memory (ROM). The memory device 94 may store a variety of information and may be used for various purposes. For example, the memory device 94 may store processor-executable instructions (e.g., firmware or software) for the processor 92 to execute, such as instructions for receiving the bale wrap presence signal from the bale wrap presence sensor 78 and the bale absence signal from the bale absence sensor 82, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for receiving the bale wrap presence signal from the bale wrap presence sensor 78 and the bale absence signal from the bale absence sensor 82, etc.), and any other suitable data.

In the illustrated embodiment, the bale ejection control system 76 includes a user interface 96 communicatively coupled to the controller 90. The user interface 96 receives input from an operator and provides information to the operator. The user interface 96 may include any suitable input device(s) for receiving input, such as a keyboard, a mouse, button(s), switch(es), knob(s), other suitable input device(s), or a combination thereof. In addition, the user interface 96 may include any suitable output device(s) for presenting information to the operator, such as speaker(s), indicator light(s), other suitable output device(s), or a combination thereof. In the illustrated embodiment, the user interface 96 includes a display 98 that presents visual information to the operator. In certain embodiments, the display 98 may include a touchscreen interface that receives input from the operator.

The controller 90 is configured to determine the bale wrapping process is complete based on presence of the bale wrap 58 on the bale 14 (e.g., feedback from the bale wrap presence sensor 78). For example, the controller 90 may determine the bale wrapping process is complete in response to receiving a bale wrap presence signal from an ultrasonic sensor indicative of a return ultrasonic signal magnitude greater than a threshold magnitude (e.g., because the ultrasonic reflectivity of the bale wrap 58 is greater than the ultrasonic reflectivity of the agricultural product of the bale 14). Furthermore, the controller 90 may determine the bale wrapping process is complete in response to receiving a bale wrap presence signal from a color contrast sensor indicative of a difference in color greater than a threshold color contrast (e.g., because the bale wrap 58 and the agricultural product of the bale 14 have different colors). In addition, in certain embodiments, the controller may determine the bale wrapping process is complete in response to receiving a bale wrap presence signal from a camera indicative of an image corresponding to presence of the bale wrap on the bale. Furthermore, in certain embodiments, the controller may determine the bale wrapping process is complete in response to receiving a bale wrap presence signal from a LiDAR sensor, an infrared sensor, a millimeter wave sensor, or a terahertz sensor indicative of a return signal corresponding to the presence of the bale wrap on the bale (e.g., because the reflectivity of the bale wrap is different than the reflectivity of the agricultural product of the bale).

In certain embodiments, presence of the bale wrap 58 on the bale 14 corresponds to a number of layers of the bale wrap 58 over the agricultural product of the bale 14. In such embodiments, the controller 90 is configured to determine the bale wrapping process is complete in response to determining the number of layers of the bale wrap 58 is equal to a target number of layers (e.g., 1, 2, 3, 4, 5, 6, 7, 8, or more). In embodiments in which the bale wrap presence sensor 78 includes an ultrasonic sensor, the ultrasonic sensor may monitor the number of layers based on the return ultrasonic signal magnitude (e.g., because the reflectivity of the bale wrap may increase with the number of layers). Furthermore, in embodiments in which the bale wrap presence sensor 78 includes a color contrast sensor, the color contrast sensor may monitor the number of layers based on the color contrast (e.g., the color contrast between the agricultural product and the bale wrap may increase as the number of layers increases). In addition, in embodiments in which the bale wrap presence sensor 78 includes a LiDAR sensor, an infrared sensor, a millimeter wave sensor, or a terahertz sensor, the respective sensor may monitor the number of layers based on the respective return signal (e.g., because the reflectivity of the bale wrap may increase with the number of layers).

While the bale ejection control system 76 includes one bale wrap presence sensor 78 in the illustrated embodiment, in other embodiments, the bale ejection control system may include more bale wrap presence sensors (e.g., 2, 3, 4, or more). In addition, in certain embodiments, the bale ejection control system may include one or more cameras directed toward the bale, in which the camera(s) output signal(s) indicative of image(s) of the bale and/or the bale wrap. In such embodiments, the user interface may receive the signal(s) directly and/or via the controller, and the display of the user interface may present the image(s) to the operator, thereby enabling the operator to verify presence of the bale wrap on the bale.

In addition, the controller 90 is configured to determine the bale handler 22 is available based on absence of the previous bale on the bale handler 22 (e.g., feedback from the bale absence sensor 82). For example, the controller 90 may determine the bale handler 22 is available in response to receiving a bale absence signal from a fluid pressure sensor indicative of a fluid pressure within the hydraulic cylinder 82 less than a threshold fluid pressure (e.g., because the lower fluid pressure indicates that the weight of a previous bale is not being supported by the hydraulic cylinder 72). Furthermore, in certain embodiments, the controller 90 may determine the bale handler 22 is available in response to receiving a bale absence signal from a pressure switch positioned on the bale handler 22 indicative of no contact between a previous bale and the pressure switch, thereby indicating that no previous bale is present on the bale handler 22. In addition, in certain embodiments, the controller 90 may determine the bale handler 22 is available in response to receiving a bale absence signal from a strain gauge coupled to the bale handler 22 indicative of a deflection less than a threshold deflection (e.g., because the lower deflection indicates that the weight of a previous bale is not being supported by the bale handler 22). Furthermore, in certain embodiments, the controller 90 may determine the bale handler 22 is available in response to receiving a bale absence signal indicative of an image corresponding to absence of a previous bale on the bale handler 22.

In response to determining the bale wrapping process is complete and the bale handler 22 is available, the controller 90 controls the bale ejection system 100 to eject the bale from the baler. For example, as previously discussed, the bale ejection system 100 may include one or more actuators that drive the pendulum arms of the baler to rotate from the bale formation position to the bale ejection position, thereby ejecting the wrapped bale from the baler to the bale handler 22. Furthermore, in certain embodiments, the controller 90 is configured to control the user interface 96 to present an indication that the bale wrap 58 is present on the bale 14. For example, the controller 90 may instruct the display 98 of the user interface 96 to present a visual indication that the bale wrap 58 is present on the bale 14.

Furthermore, in certain embodiments, in response to determining the bale wrapping process is complete and the bale handler is available, the controller may control another suitable component of the agricultural harvester (e.g., the hydraulic cylinder of the bale handler system, a drive system of the agricultural harvester, the conveying system of the agricultural product transport assembly, the air-assisted conveying system, etc.). For example, in certain embodiments, in response to determining the bale wrapping process is complete and the bale handler is available, the controller may control the hydraulic cylinder of the bale handler system to drive the bale handler from the transport position (e.g., home position) to the receiving position. Accordingly, the bale handler may be positioned to receive the wrapped bale.

As illustrated, the operator presence sensor 84 of the bale ejection control system 76 is communicatively coupled to the controller 90. As previously discussed, the operator presence sensor 84 outputs an operator presence signal indicative of presence of the operator within the cab 86 of the agricultural harvester. The operator presence sensor 84 may include any suitable type(s) of sensing device(s) that monitor operator presence within the cab 86. For example, the operator presence sensor 84 may include a seat sensor that monitors the weight of the operator in the seat. Furthermore, the operator presence sensor may include a passive infrared sensor directed toward the seat, in which the passive infrared sensor monitors heat emitted by the operator. In addition, the operator presence sensor may include a camera directed towards the seat, in which the camera outputs an image of the operator. The controller 90 is configured to receive the operator presence signal from the operator presence sensor 84 and to determine the operator is present based on the presence of the operator within the cab 86. In certain embodiments, the controller is configured to control the bale ejection system to eject the bale 14 from the baler 12 in response to determining the bale wrapping process is complete, the bale handler 22 is available, and the operator is present. Because the operator is in the cab during the harvesting process, ejecting the bale only while the operator is in the cab may cause the bale to be ejected only during the harvesting process.

Furthermore, as illustrated, the position sensor 88 of the bale ejection control system 76 is communicatively coupled to the controller 90. The position sensor 88 outputs a position signal indicative of a position of the agricultural harvester 10 within a field and, in certain embodiments, a speed signal indicative of a speed of the agricultural harvester through the field. The position sensor 88 may include any suitable type(s) of position sensing device(s), such as a global positioning system (GPS) receiver, an inertial measurement unit (IMU), other suitable type(s) of position sensing device(s), or a combination thereof. The controller is configured to receive the position signal from the position sensor 88 and to determine the agricultural harvester is at a target position based on the position of the agricultural harvester. For example, the controller 90 may store a map with a target location for ejecting each bale. The controller 90 may determine that the agricultural harvester is at the target position in response to determining a difference between the target position and the position of the agricultural harvester within the field is less than a threshold distance. In certain embodiments, the controller 90 is configured to control the bale ejection system 100 to eject the bale from the baler in response to determining the bale wrapping process is complete, the bale handler is available, and the agricultural harvester is at the target position.

In addition, in certain embodiments, the controller 90 is configured to receive the speed signal indicative of the speed of the agricultural harvester through the field from the position sensor 88 and to determine the agricultural harvester is within a target speed range based on the speed of the agricultural harvester. Furthermore, the controller is configured to control the bale ejection system to eject the bale from the baler in response to determining the bale wrapping process is complete, the bale handler is available, and the agricultural harvester is within the target speed range. The target speed range may be selected to correspond to the speed range of the agricultural harvester during the harvesting process. Accordingly, the bale ejection control system may only eject the bale during the harvesting process. While the controller receives the speed signal from the position sensor in certain embodiments, in other embodiments, the controller may receive the speed signal from another suitable speed sensor (e.g., separate from the position sensor), such as a speed sensor that monitors a rotational speed of the wheels of the agricultural harvester.

Furthermore, in certain embodiments, the controller 90 is configured to determine an operating state of the agricultural harvester. The operating states may include a harvesting operating state, in which the agricultural harvester is harvesting agricultural product, a transport state, in which the agricultural harvester is moving between locations and not harvesting agricultural product, and a fault state, in which a fault is detected and the agricultural harvester is not harvesting agricultural product. For example, while the agricultural harvester is in the harvesting operating state, the conveying air source is operating, the row units are operating, and the row units are engaged with the agricultural product. Furthermore, while the agricultural harvester is in the transport state, the conveying air source is not operating, the row units are not operating, and the row units are not engaged with the agricultural product. In addition, while the agricultural harvester is in the fault state, a fault may be present within a drive system of the agricultural harvester, within a hydraulic system of the agricultural harvester, within other system(s) of the agricultural harvester, or a combination thereof. The controller may determine the operating state of the agricultural harvester based on operator input (e.g., whether the operator has provided input to the user interface indicative of instructions to initiate harvesting operations) and/or based on feedback from one or more sensor(s) (e.g., crop engagement sensor(s), spindle speed sensor(s), conveying air source speed sensor(s), hydraulic pressure sensor(s), engine operation sensor(s), etc.). In certain embodiments, the controller 90 is configured to control the bale ejection system 100 to eject the bale from the baler in response to determining the bale wrapping process is complete, the bale handler is available, and the agricultural harvester is in the harvesting operating state. Accordingly, the bale ejection control system may only eject the bale during the harvesting process.

In certain embodiments, the controller 90 is configured to determine a position of the bale handler 22 of the bale handler system 24. For example, the controller 90 may determine the position of the bale handler 22 based on extension of the hydraulic cylinder 72 (e.g., the extension commanded by the controller 90). Furthermore, the controller 90 may determine the position of the bale handler 22 based on feedback from a bale handler position sensor communicatively coupled to the controller. The bale handler position sensor outputs a bale handler position signal indicative of the position of the bale handler. For example, the bale handler position sensor may monitor an extension of the hydraulic cylinder and/or the angle of the bale handler relative to the ramp. In certain embodiments, the controller 90 is configured to control the bale ejection system 100 to eject the bale from the baler in response to determining the bale wrapping process is complete, the bale handler is available, and the bale handler 22 is in the receiving position. Accordingly, the bale ejection control system may only eject the bale while the bale handler is configured for receiving the bale.

In addition, in certain embodiments, the bale ejection control system includes a steering angle sensor communicatively coupled to the controller. The steering angle sensor outputs a steering angle signal indicative of a steering angle of the agricultural harvester (e.g., an angle of the front wheels, an angle of the rear wheels, etc.). The controller is configured to receive the steering angle signal and to determine the steering angle based on feedback from the steering angle sensor. In certain embodiments, the controller is configured to control the bale ejection system to eject the bale from the baler in response to determining the bale wrapping process is complete, the bale handler is available, and the steering angle is less than a threshold steering angle. The threshold steering angle may be selected, such that the bale remains aligned with the bale handler as the bale moves from the baler to the bale handler.

Furthermore, in certain embodiments, the bale ejection control system includes a tilt sensor communicatively coupled to the controller. The tilt sensor outputs a tilt signal indicative of a fore-aft tilt angle (e.g., tilt about a lateral axis) and/or a side-to-side tilt angle (e.g., tilt about a longitudinal axis) of the agricultural harvester. The controller is configured to receive the tilt signal and to determine the tilt angle(s) (e.g., the fore-aft tilt angle and/or the side-to-side tilt angle) of the agricultural harvester based on feedback from the tilt sensor. In certain embodiments, the controller is configured to control the bale ejection system to eject the bale from the baler in response to determining the bale wrapping process is complete, the bale handler is available, and the tilt angle(s) are less than threshold tilt angle(s). The threshold tilt angle(s) may be selected, such that the bale remains aligned with the bale handler as the bale moves from the baler to the bale handler. While various conditions for automatically ejecting the bale from the baler are disclosed above, in certain embodiments, the controller may determine/consider other suitable condition(s).

As previously discussed, in certain embodiments, the controller 90 is configured to control the bale ejection system 100 to eject the bale from the baler in response to determining the bale wrapping process is complete and the bale handler is available. Furthermore, in certain embodiments, the controller 90 is configured to control the bale ejection system 100 to eject the bale from the baler in response to determining the bale wrapping process is complete, the bale handler is available, and at least one other condition for automatically ejecting the bale from the baler disclosed above is satisfied. For example, in certain embodiments, the controller 90 may control the bale ejection system 100 to eject the bale from the baler in response to determining the bale wrapping process is complete, the bale handler is available, and at least one of the agricultural harvester is in the harvesting operating state, the operator is present within the cab, the agricultural harvester is at the target position, the agricultural harvester is within the target speed range, the bale handler is in the receiving position, the steering angle is less than the threshold steering angle, or the tilt angle(s) are less than the threshold tilt angle(s). For each condition that is not determined/considered by the controller, the associated/corresponding sensor may be omitted.

Furthermore, in certain embodiments, the controller 90 is configured to control the user interface 96 to present an eject stoppage notification in response to determining the bale wrapping process is complete and at least one of the other conditions (e.g., the bale handler is available, the agricultural harvester is in the operating state, the operator is present in the cab, the agricultural harvester is at the target location, the agricultural harvester is within the target speed range) is not satisfied. In response to receiving the notification, the operator may take action(s) to resolve the unsatisfied condition(s), thereby enabling the bale ejection control system to proceed to eject the bale from the baler.

In certain embodiments, the controller 90 is configured to receive a bale eject termination signal from the user interface 96. In such embodiments, the controller 90 is configured to control the bale ejection system 100 to eject the bale from the baler in response to determining the bale wrapping process is complete, the bale handler is available, the bale eject termination signal is not received, and, in certain embodiments, any of the other conditions for automatically ejecting the bale from the baler disclosed above are satisfied. For example, if ejecting the bale from the baler is not desired when the conditions for automatically ejecting the bale from the baler are satisfied, the operator may provide an input to the user interface indicative of instructions to block initiation of the bale ejection process, and the user interface may output the bale eject termination signal indicative of the instructions. The controller, in turn, may not control the bale ejection system to eject the bale from the baler even while the conditions for automatically ejecting the bale from the baler are satisfied. In certain embodiments, in response to receiving the bale eject termination signal, the controller disables the automatic bale ejection process until the controller receives a bale eject activation signal from the user interface, which is indicative of activation (e.g., reactivation) of the automatic bale ejection process. Furthermore, in certain embodiments, the controller may automatically reactivate the automatic bale ejection process after a bale is ejected from the baler.

While automatic control of the bale ejection process is disabled, the controller may enable manual control of the bale ejection system for ejecting the bale from the baler. For example, in response to determining that each of the conditions for automatically ejecting the bale from the baler is satisfied, the controller may control the user interface to present an indication that the bale may be ejected from the baler. Upon receiving the indication, the operator may provide an input to the user interface indicative of instructions to eject the bale from the baler (e.g., when the agricultural harvester is positioned at a desired location within the field), and the user interface may output a signal indicative of the instructions to the controller. The controller, in turn, may control the bale ejection system to eject the bale from the baler. Furthermore, in certain embodiments, the controller may be configured to terminate the bale ejection process after the bale ejection process has been initiated (e.g., automatically or manually) in response to receiving a stop/pause signal (e.g., which may correspond to the bale eject termination signal) from the user interface.

In certain embodiments, the controller 90 is configured to receive a bale eject signal from the user interface 96 and to control the bale ejection system 100 to eject the bale from the baler in response to receiving the bale eject signal. For example, if at least one of the conditions for automatically ejecting the bale from the baler is not satisfied (e.g., the agricultural harvester is not in the harvesting operating state, the operator is not present within the cab, the agricultural harvester is not at the target position, the agricultural harvester is not within the target speed range), the operator may provide an input to the user interface 96 indicative of instructions to eject the bale (e.g., override automatic control of bale ejection), and the user interface 96 may output a signal to the controller 90 indicative of the instructions. The controller 90, in turn, may control the bale ejection system 100 to eject the bale from the baler even though at least one of the conditions for automatically ejecting the bale from the baler is not satisfied.

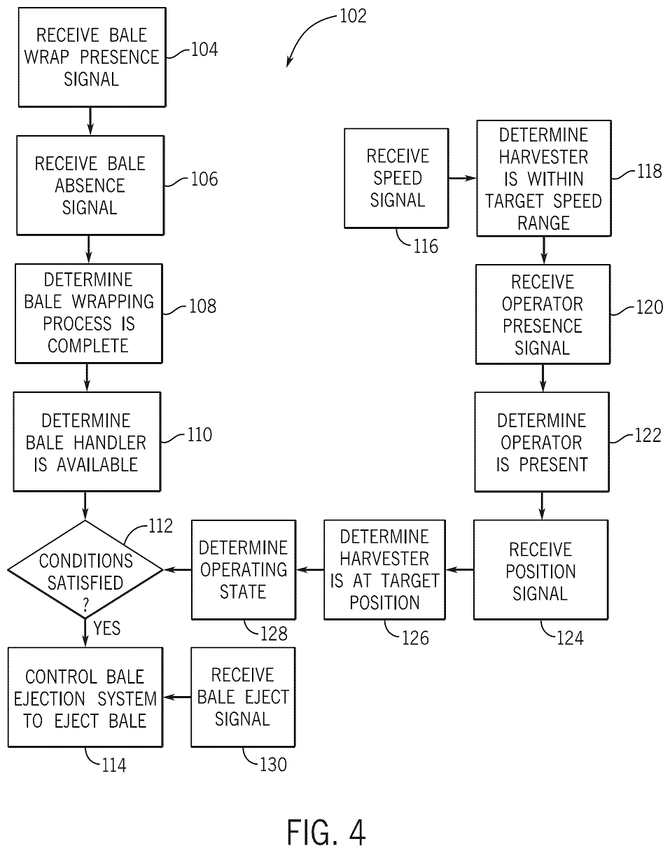

FIG. 4 is a flow diagram of an embodiment of a method 102 for ejecting a bale of agricultural product from a baler. The method 102 may be performed by the controller disclosed above with reference to FIG. 3, by one or more other suitable controllers, or a combination thereof. Furthermore, the steps of the method 102 may be performed in the order disclosed below or in any other suitable order. In addition, in certain embodiments, one or more steps of the method 102 may be omitted, and/or the method may include one or more additional steps.

In the illustrated embodiment, the method 102 includes receiving a bale wrap presence signal indicative of presence of the bale wrap on the bale within the baler, as represented by block 104. As previously discussed, the bale wrap presence signal may be received from a bale wrap presence sensor. The method 102 also includes receiving a bale absence signal indicative of absence of a previous bale on the bale handler, as represented by block 106. As previously discussed, the bale absence signal may be received from a bale absence sensor. Furthermore, the method 102 includes determining the bale wrapping process is complete based on presence of the bale wrap on the bale, as represented by block 108, and determining the bale handler is available based on absence of the previous bale on the bale handler, as represented by block 110.

As represented by block 112, a determination is made regarding whether conditions for automatically ejecting the bale from the baler are satisfied. As previously discussed, the conditions include at least the bale wrapping process being complete and the bale handler being available. As discussed in detail below, the conditions may also include one or more additional conditions for automatically ejecting the bale from the baler. In response to determining the conditions are satisfied (e.g., at least the bale wrapping process is complete and the bale handler is available), the bale ejection system is controlled to eject the bale from the baler, as represented by block 114.

In certain embodiments, the method 102 includes receiving a speed signal indicative of the speed of the agricultural harvester through the field, as represented by block 116. As previously discussed, the speed signal may be received from the position sensor or another suitable speed sensor. The method 102 also includes determining the agricultural harvester is within a target speed range based on the speed of the agricultural harvester, as represented by block 118. In certain embodiments, determining whether the conditions for automatically ejecting the bale from the baler are satisfied, as represented by block 112, includes determining whether the agricultural harvester is within the target speed range.

Furthermore, in certain embodiments, the method 102 includes receiving an operator presence signal indicative of presence of the operator within the cab of the agricultural harvester, as represented by block 120. As previously discussed, the operator presence signal may be received from the operator presence sensor. The method 102 also includes determining the operator is present based on the presence of the operator within the cab, as represented by block 122. In certain embodiments, determining whether the conditions for automatically ejecting the bale from the baler are satisfied, as represented by block 112, includes determining whether the operator is present within the cab.

In addition, in certain embodiments, the method 102 includes receiving a position signal indicative of the position of the agricultural harvester within the field, as represented by block 124. As previously discussed, the position signal may be received from the position sensor. The method 102 also includes determining the agricultural harvester is at the target position based on the position of the agricultural harvester, as represented by block 126. In certain embodiments, determining whether the conditions for automatically ejecting the bale from the baler are satisfied, as represented by block 112, includes determining whether the agricultural harvester is at the target position.

Furthermore, in certain embodiments, the method 102 includes determining an operating state of the agricultural harvester, as represented by block 128. As previously discussed, the operating states may include the harvesting operating state, the transport state, and the fault state. In certain embodiments, determining whether the conditions for automatically ejecting the bale from the baler are satisfied, as represented by block 112, includes determining whether the agricultural harvester is in the harvesting operating state. Furthermore, in certain embodiments, determining whether the conditions for automatically ejecting the bale from the baler are satisfied includes determining whether the bale eject termination signal is not received.

In certain embodiments, the method 102 includes receiving a bale eject signal from the user interface, as represented by block 130. In response to receiving the bale eject signal, the bale ejection system is controlled to eject the bale from the baler, as represented by block 114. Accordingly, the bale may be manually ejected even if the conditions for automatically ejecting the bale from the baler are not satisfied.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical.

1. A bale ejection control system for an agricultural harvester, comprising:
a controller comprising a processor and a memory, wherein the controller is configured to:
receive a bale wrap presence signal indicative of presence of a bale wrap on a bale of agricultural product within a baler of the agricultural harvester;
receive a bale absence signal indicative of absence of a previous bale on a bale handler of the agricultural harvester;
determine a bale wrapping process is complete based on presence of the bale wrap on the bale;
determine the bale handler is available based on absence of the previous bale on the bale handler; and
control a bale ejection system to eject the bale from the baler in response to determining the bale wrapping process is complete and the bale handler is available.

2. The bale ejection control system of claim 1, wherein the controller is configured to receive a bale eject signal from a user interface and to control the bale ejection system to eject the bale from the baler in response to receiving the bale eject signal.

3. The bale ejection control system of claim 1, wherein the controller is configured to receive a bale eject termination signal from a user interface, and the controller is configured to control the bale ejection system to eject the bale from the baler in response to determining the bale wrapping process is complete, the bale handler is available, and the bale eject termination signal is not received.

4. The bale ejection control system of claim 1, wherein the controller is configured to:
determine an operating state of the agricultural harvester; and
control the bale ejection system to eject the bale from the baler in response to determining the bale wrapping process is complete, the bale handler is available, and the agricultural harvester is in a harvesting operating state.

5. The bale ejection control system of claim 1, wherein the controller is configured to:
receive an operator presence signal indicative of presence of an operator within a cab of the agricultural harvester;
determine the operator is present based on the presence of the operator within the cab; and
control the bale ejection system to eject the bale from the baler in response to determining the bale wrapping process is complete, the bale handler is available, and the operator is present.

6. The bale ejection control system of claim 1, wherein the controller is configured to:
receive a position signal indicative of a position of the agricultural harvester within a field;
determine the agricultural harvester is at a target position based on the position of the agricultural harvester; and
control the bale ejection system to eject the bale from the baler in response to determining the bale wrapping process is complete, the bale handler is available, and the agricultural harvester is at the target position.

7. The bale ejection control system of claim 1, wherein the controller is configured to:
receive a speed signal indicative of a speed of the agricultural harvester through a field;
determine the agricultural harvester is within a target speed range based on the speed of the agricultural harvester; and
control the bale ejection system to eject the bale from the baler in response to determining the bale wrapping process is complete, the bale handler is available, and the agricultural harvester is within the target speed range.

8. A bale ejection control system for an agricultural harvester, comprising:
a bale wrap presence sensor directed towards a bale of agricultural product within a baler of the agricultural harvester, wherein the bale wrap presence outputs a bale wrap presence signal indicative of presence of a bale wrap on the bale;
a bale absence sensor that outputs a bale absence signal indicative of absence of a previous bale on a bale handler of the agricultural harvester; and
a controller communicatively coupled to the bale wrap presence sensor and to the bale absence sensor, wherein the controller comprises a processor and a memory, and the controller is configured to:
receive the bale wrap presence signal from the bale wrap presence sensor;
receive the bale absence signal from the bale absence sensor;
determine a bale wrapping process is complete based on presence of the bale wrap on the bale;
determine the bale handler is available based on absence of the previous bale on the bale handler; and
control a bale ejection system to eject the bale from the baler in response to determining the bale wrapping process is complete and the bale handler is available.

9. The bale ejection control system of claim 8, wherein the bale wrap presence sensor comprises a tag reader, an ultrasonic sensor, a color contrast sensor, a camera, an infrared sensor, a LiDAR sensor, or a combination thereof.

10. The bale ejection control system of claim 8, wherein the bale absence sensor comprises a fluid pressure sensor that monitors a fluid pressure within a hydraulic cylinder coupled to the bale handler, a pressure switch positioned on the bale handler, a camera directed towards the bale handler, a LiDAR sensor directed towards the bale handler, a strain gauge coupled to the bale handler, a load pin coupled to the bale handler, or a combination thereof.

11. The bale ejection control system of claim 8, comprising a user interface communicatively coupled to the controller, wherein the controller is configured to receive a bale eject signal from the user interface and to control the bale ejection system to eject the bale from the baler in response to receiving the bale eject signal.

12. The bale ejection control system of claim 8, wherein the controller is configured to:
determine an operating state of the agricultural harvester; and
control the bale ejection system to eject the bale from the baler in response to determining the bale wrapping process is complete, the bale handler is available, and the agricultural harvester is in a harvesting operating state.

13. The bale ejection control system of claim 8, comprising an operator presence sensor that outputs an operator presence signal indicative of presence of an operator within a cab of the agricultural harvester;
wherein the controller is communicatively coupled to the operator presence sensor, and the controller is configured to:
receive the operator presence signal from the operator presence sensor;
determine the operator is present based on the presence of the operator within the cab; and
control the bale ejection system to eject the bale from the baler in response to determining the bale wrapping process is complete, the bale handler is available, and the operator is present.

14. The bale ejection control system of claim 8, comprising a position sensor that outputs a position signal indicative of a position of the agricultural harvester within a field;
wherein the controller is communicatively coupled to the position sensor, and the controller is configured to:
receive the position signal from the position sensor;
determine the agricultural harvester is at a target position based on the position of the agricultural harvester; and
control the bale ejection system to eject the bale from the baler in response to determining the bale wrapping process is complete, the bale handler is available, and the agricultural harvester is at the target position.

15. The bale ejection control system of claim 8, comprising a user interface communicatively coupled to the controller, wherein the controller is configured to receive a bale eject termination signal from the user interface, and the controller is configured to control the bale ejection system to eject the bale from the baler in response to determining the bale wrapping process is complete, the bale handler is available, and the bale eject termination signal is not received.

16. A method for ejecting a bale of agricultural product from a baler of an agricultural harvester, comprising:
receiving, via a controller comprising a processor and a memory, a bale wrap presence signal indicative of presence of a bale wrap on the bale within the baler;
receiving, via the controller, a bale absence signal indicative of absence of a previous bale on a bale handler of the agricultural harvester;
determining, via the controller, a bale wrapping process is complete based on presence of the bale wrap on the bale;
determining, via the controller, the bale handler is available based on absence of the previous bale on the bale handler; and
controlling, via the controller, a bale ejection system to eject the bale from the baler in response to determining the bale wrapping process is complete and the bale handler is available.

17. The method of claim 16, comprising:
receiving, via the controller, a bale eject signal from a user interface; and
controlling, via the controller, the bale ejection system to eject the bale from the baler in response to receiving the bale eject signal.

18. The method of claim 16, wherein controlling the bale ejection system to eject the bale from the baler comprises controlling the bale ejection system to eject the bale from the baler in response to determining the bale wrapping process is complete, the bale handler is available, and a bale eject termination signal is not received from a user interface.

19. The method of claim 16, comprising determining, via the controller, an operating state of the agricultural harvester, wherein controlling the bale ejection system to eject the bale from the baler comprises controlling the bale ejection system to eject the bale from the baler in response to determining the bale wrapping process is complete, the bale handler is available, and the agricultural harvester is in a harvesting operating state.

20. The method of claim 16, comprising:
receiving, via the controller, a position signal indicative of a position of the agricultural harvester within a field; and
determining, via the controller, the agricultural harvester is at a target position based on the position of the agricultural harvester;
wherein controlling the bale ejection system to eject the bale from the baler comprises controlling the bale ejection system to eject the bale from the baler in response to determining the bale wrapping process is complete, the bale handler is available, and the agricultural harvester is at the target position.
